(19) United States
(12) Patent Application Publication
(10) Pub. No.: US 2018/0247530 A1
(43) Pub. Date: Aug. 30, 2018

(54) HIGHWAY LIGHT SYSTEM

(71) Applicant: Ford Global Technologies, LLC, Dearborn, MI (US)

(72) Inventors: Jakob Nikolaus HOELLERBAUER, Canton, MI (US); Brennan HAMILTON, Birmingham, MI (US); John William SCHMOTZER, Canton, MI (US)

(73) Assignee: Ford Global Technologies, LLC, Dearborn, MI (US)

(21) Appl. No.: 15/758,094

(22) PCT Filed: Oct. 21, 2015
(86) PCT No.: PCT/US15/56633

§ 371 Date: Mar. 7, 2018

(51) Int. Cl. G08G 1/065; G08G 1/01; H04W 4/46; H05B 37/02

(52) U.S. Cl. CPC G08G 1/065; G08G 1/0112; H05B 37/0218; H05B 37/0227; H05B 37/0272; H04W 4/46

(57) ABSTRACT

A vehicle-to-vehicle communication system may include at least one light and at least one controller configured to receive vehicle data indicative of vehicle traffic from a vehicle via vehicle-to-vehicle communication and to control a light state based on the vehicle traffic, wherein the light state changes when the vehicle data indicates vehicle traffic falling outside of a traffic range

### TECHNICAL FIELD

Disclosed herein are highway light systems.

### BACKGROUND

Highway lighting systems are subject to wear and tear, and often require large amounts of maintenance and upkeep. Moreover, continually operated lights increase maintenance requirements as well energy and power requirements.

### SUMMARY

A vehicle-to-vehicle communication system may include at least one light and at least one controller configured to receive vehicle data indicative of vehicle traffic from a vehicle via vehicle-to-vehicle communication and to control a light state based on the vehicle traffic, wherein the light state changes when the vehicle data indicates vehicle traffic falling outside of a traffic range.

A highway lighting system may include at least one light and at least one controller configured to receive vehicle data indicative of vehicle traffic from a vehicle via vehicle-to-vehicle communication and to turn on the light in response to the vehicle traffic exceeding a threshold.

A highway lighting system may include at least one light, a transceiver, and at least one controller configured to receive vehicle data from a vehicle via vehicle-to-vehicle communication, the vehicle data indicating a presence of at least one vehicle within a predefined radius of the transceiver, and instruct the light to turn on in response to the vehicle data indicating a traffic level exceeding a traffic threshold.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIGS. 1A and 1B illustrate an example diagram of a system that may be used to provide telematics services to a vehicle;

FIG. 2 illustrates an example block diagram of a portion of a lighting system;

FIGS. 3A-3C illustrate example situations for the lighting system; and

FIG. 4 illustrates an example process for the lighting system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein are highway systems configured to illuminate highways in response to vehicle data received from vehicles and/or other lighting systems via vehicle-to-vehicle communications. Highway systems in the United States are integral to fast, efficient, and convenient transportation of goods and people across the country. Millions of vehicles use these systems over the course of a single day. The vast majority of current light systems may continually be illuminated, or at least continually illuminated at night. Continual illumination of lights may be inefficient and costly both in energy and maintenance costs. This may be the case at night when there are fewer vehicles on the road. Using vehicle data to estimate vehicle traffic patterns and various vehicle paths to selectively illuminate lights within a highway may increase the life-span of such light systems, as well as decrease costs associated with maintenance and energy requirements.

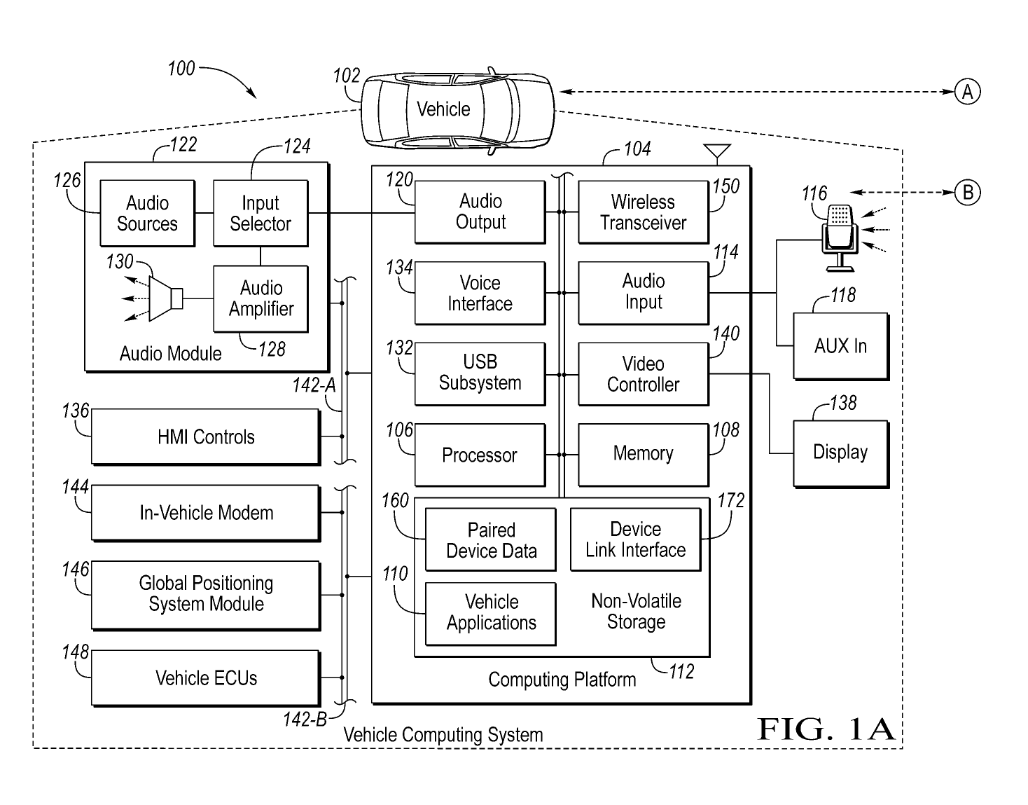

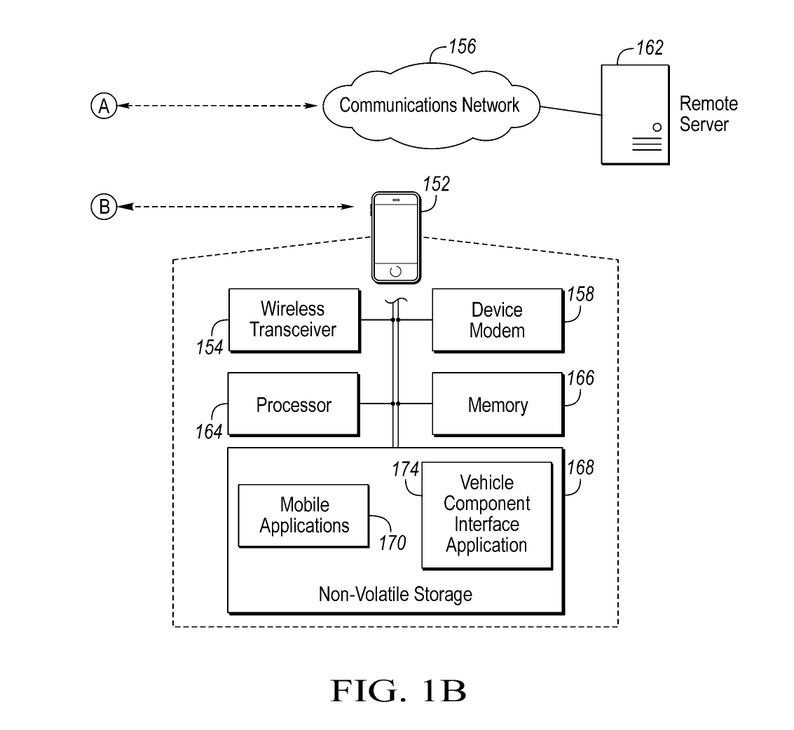

FIGS. 1A and 1B illustrate an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 and controllers configured to perform instructions, commands and other routines in support of the processes described herein. For instance, the computing platform 104 may be configured to execute instructions of vehicle applications 110 to provide features such as navigation, accident reporting, satellite radio decoding, hands-free calling and parking assistance. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif. The vehicle component interface application 174 may be once such application installed to the mobile device 152.

The vehicle component interface application 174 of the mobile device 152 may be configured to facilitate access to one or more vehicle 102 features made available for device configuration by the vehicle 102. In some cases, the available vehicle 102 features may be accessible by a single vehicle component interface application 174, in which case such the vehicle component interface application 174 may be configured to be customizable or to maintain configurations supportive of the specific vehicle 102 brand/model and option packages. In an example, the vehicle component interface application 174 may be configured to receive, from the vehicle 102, a definition of the features that are available to be controlled, display a user interface descriptive of the available features, and provide user input from the user interface to the vehicle 102 to allow the user to control the indicated features.

Systems such as the system 100 may require mobile device 152 pairing with the computing platform 104 and/or other setup operations. However, as explained in detail below, a system may be configured to allow vehicle occupants to seamlessly interact with user interface elements in their vehicle or with any other framework-enabled vehicle, without requiring the mobile device 152 or wearable device to have been paired with or be in communication with the computing platform 104.

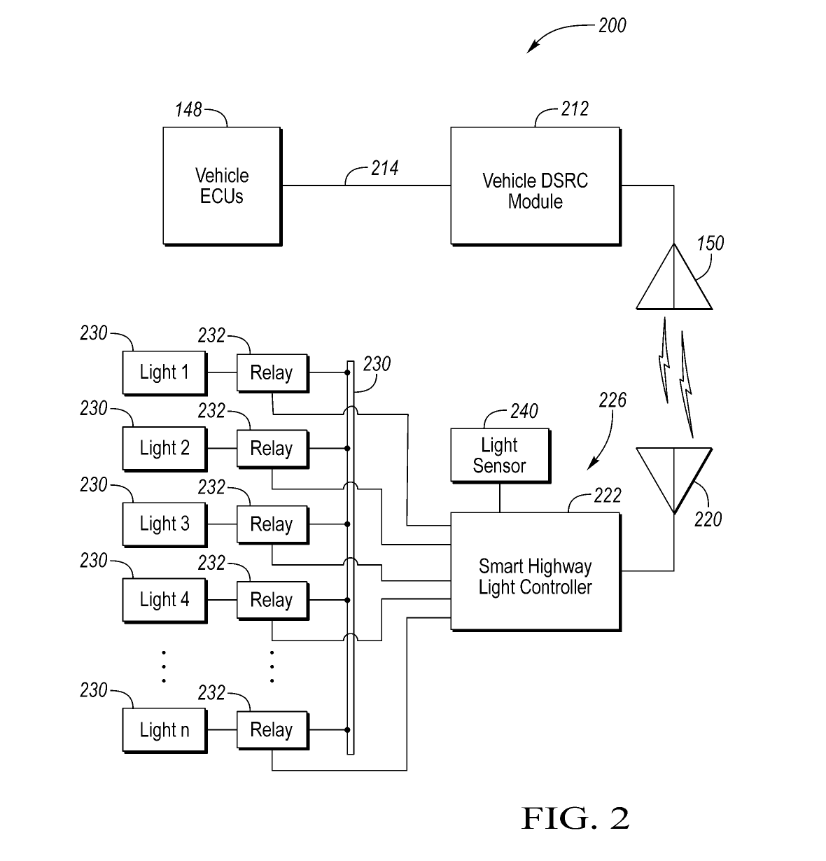

Additionally, the wireless transceiver 150 may receive and transmit data regarding the vehicle's position to other vehicles in vehicle-to-vehicle communication. The processor 106 may process such incoming vehicle position data via a vehicle DSRC module 212 as shown in FIG. 2 and described in more detail herein. As explained, the Dedicated Short-Range Communications (DSRC) module 212 may also communicate with non-vehicular devices such as highway light controllers 222. Such vehicle-to-vehicle communications may include various wireless communication protocols including near-field wireless communication, WiFi, Bluetooth™, etc. Such vehicle-to-vehicle communications may permit vehicles, as well as other components such as the light controllers 222 within light clusters 226 (see FIG. 2) to communicate directly with each other. Such data exchange may provide traffic data to the light clusters 226 for which the light controller 222 may control the lights thereof

The remote server 162 and communications network 156 may also facilitate transmission of other vehicle-to-vehicle data such as data acquired from other mobile applications and websites such as Google Maps™, Waze™, etc. In these examples, data may be shared between users and used to determine the location of other vehicles, emergency situations, etc.

FIG. 2 illustrates an example block diagram of a portion of a lighting system 200. As described above with respect to FIG. 1, various vehicle ECUs 148 may be in communication with a dedicated short range communication (DRSC) module 212 via a controller area network (CAN) bus 214. The DRSC module 212 may be in communication with the wireless transceiver 150.

The vehicle 102 may be configured to communicate using vehicle-to-vehicle wireless communication with the lighting system 200. The lighting system 200 may include a wireless transceiver 220 or antenna coupled to a highway light controller 222. The highway light controller 222 may include a processor configured to perform instructions, commands and other routines in support of the processes described herein. For instance, the controller 222 may provide and control highway lighting based on traffic flow, time of day, ambient light, traffic incidents or emergencies, etc. The controller 222 may be coupled to at least one light cluster 226. The light cluster 226 may include a plurality of lights 230 and associated relays 232. The controller 222 may control the relays 232 in order to supply power from a power supply 236 to the respective light 230.

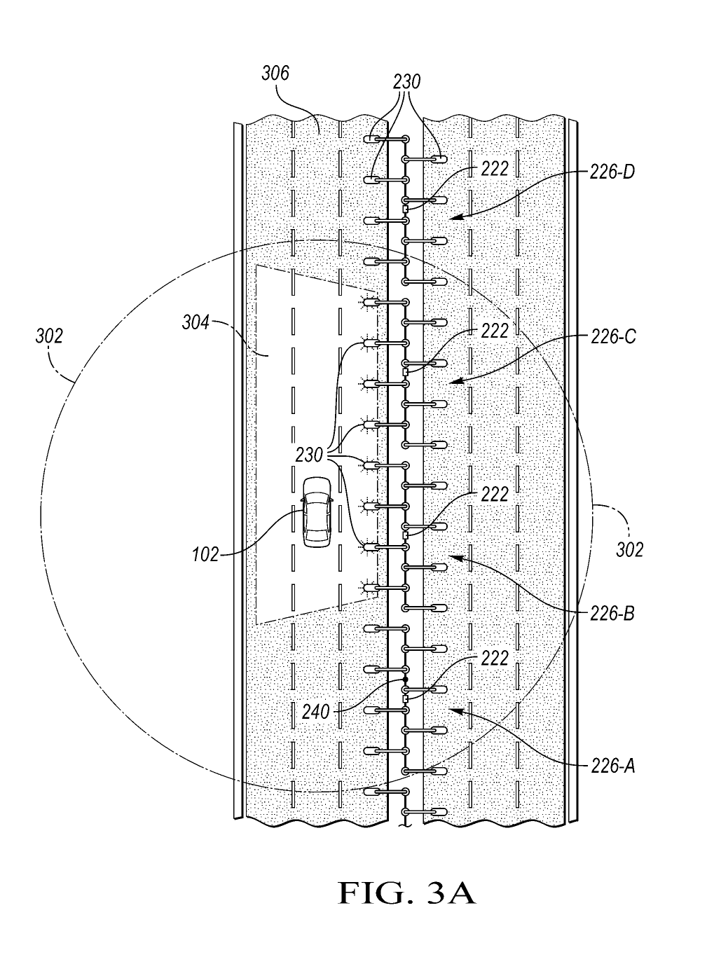

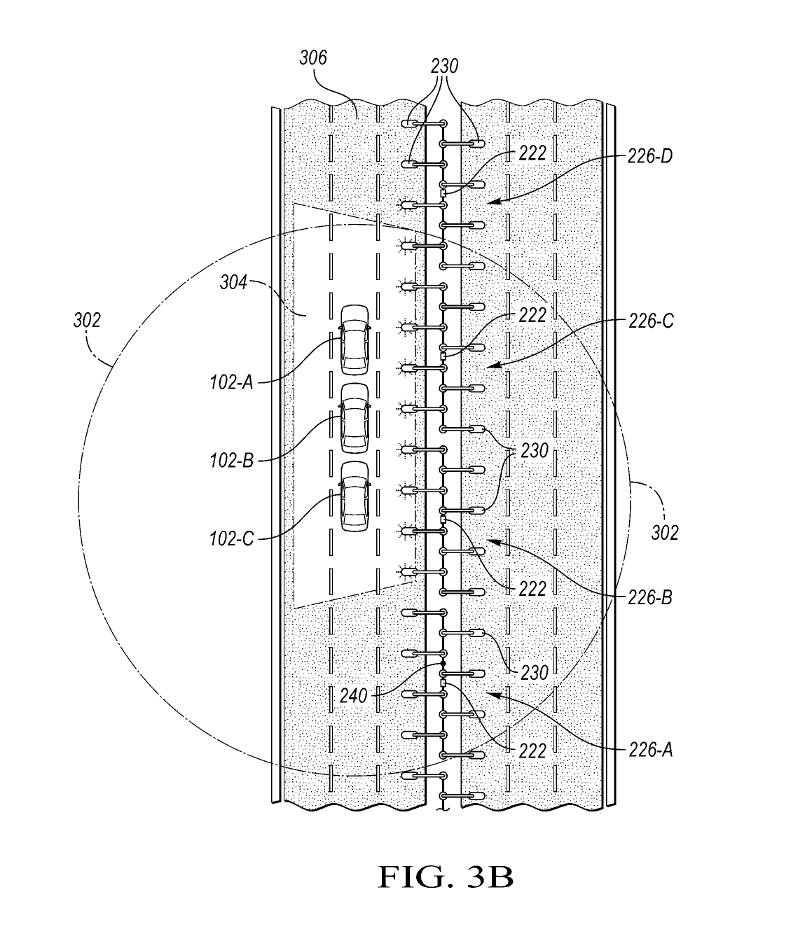

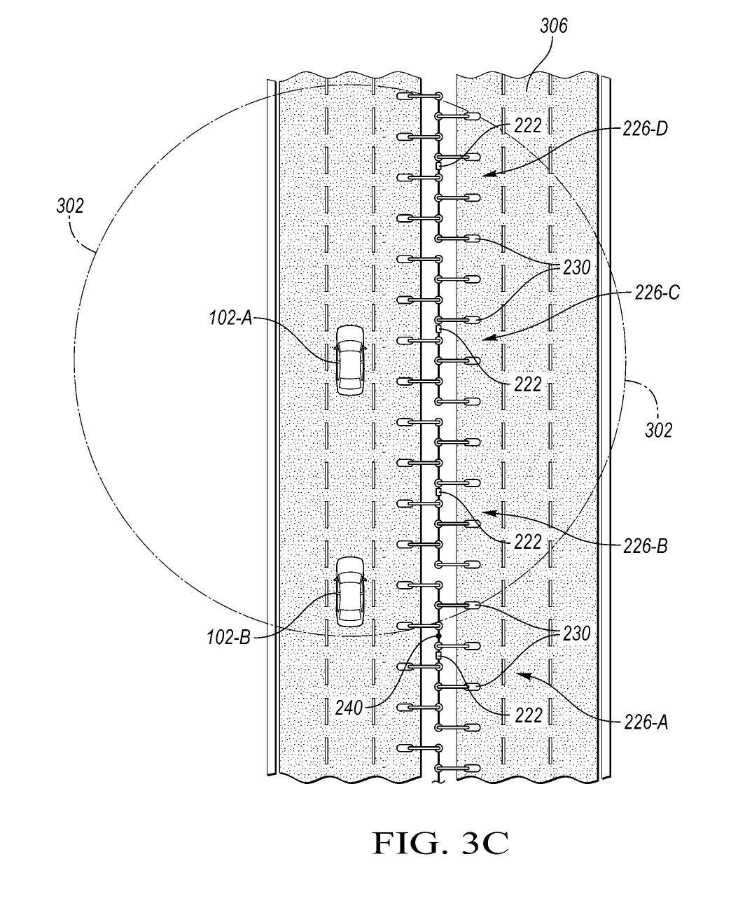

As best shown in FIG. 3, various light clusters 226 (indicated by 226-A, 226-B, 226-C, and collectively referred to as light clusters 226) may be arranged alongside of a street or highway 306. Each cluster 226 may include at least one light 230 configured to illuminate the highway area below the light. The light clusters 236 may include lights 230 for illuminating both sides of the highway 306. Each light cluster 226 may include a controller 222 configured to control the lights 230 within the light cluster 226. The controller 222 may also receive data from passing vehicles 102 via the wireless transceiver 220. Using this data, the controller 222 may determine appropriate operations of the lights 230. The controller 222 may communicate with area vehicles using vehicle-to-vehicle communication mechanisms.

The range of DRSC communications (i.e., vehicle-to-vehicle communications) may be indicated by way of example as range 302 on FIG. 3. That is, wireless communication between vehicles and the light clusters 226 may occur as long as the vehicle 102 is within the permitted range 302 of the light cluster 226. The range 302 may be a practical range for which the light cluster 226 may receive vehicle-to-vehicle communications from approaching vehicles 102. The range 302 may also be a range large enough to allow the controller 222 to adjust the lights 230 based on incoming vehicle traffic. That is, the range may be a predefined radius large enough to permit the controller 222 to recognize vehicles 102 well in advance of the vehicle coming under the lights 230 of that specific cluster 226 in order to give the cluster 226 enough time to turn on the respective lights 230. Thus, the wireless capabilities of the light cluster 226 via the transceiver 220 may be greater than a practical radius for light management purposes. In one example, the range 302 or radius may be approximately 400-1600 meters. The acceptable range 302 may vary depending on the type of road or highway 306. For example, a back road in a rural area may have a greater range at least because the area is poorly lit and lesser traveled than that of a major highway in a metropolitan area.

The vehicle 102 traveling down the highway 306 may communicate vehicle data to the light clusters 226. The vehicle data may include vehicle location and speed. Other vehicle data may also be included, including data acquired from other vehicles, destination data, etc. The light cluster 226 may receive the data where the controller 222 may evaluate the vehicle data and make a determination as to the operation of the lights 230. In the example shown in FIG. 3A, a vehicle path 304 may be recognized based on the vehicle data (e.g., the current vehicle location and vehicle speed). The vehicle path 304 may be determined by estimating the vehicle's trajectory/distance for a predetermined time period. That is, where is the vehicle heading. In the example of a highway, where little-to-know turns are likely or even possible, the determination may be how far the vehicle will travel in the next 20 seconds. That is, the faster the vehicle 102 is traveling, the further distance it will travel in a given time period. The vehicle path 304 may also be determined based on a predefined distance in front of the current vehicle location. The vehicle path 304, may indicate an acceptable distance ahead of the vehicle that may be lit. For example, the path 304 may be 200 yards in front of the current vehicle location. The determined path 304 may be used by the controller 222 to determine which lights 230 within the cluster 226 to turn on. The vehicle location may indicate which side of the highway 306 the vehicle is on. In determining the side of the highway 306, the controller 222 may illuminate, or not illuminate, the lights 230 on that respective side along the path 304. The direction the vehicle 102 is traveling may also be determined by comparing two sets of vehicle data (e.g., comparing a first location to a second location.)

In addition to the vehicle data indicating the vehicle current location and speed, the vehicle data may also be interpreted by the controller 222 to establish a traffic pattern or estimation. Whenever vehicle data is received, it may be accompanied by a certain vehicle identification (vehicle ID). The light cluster 226 may continually receive sets of vehicle data from vehicles within the range 302, each set identifying the vehicle via the vehicle ID. Each time vehicle data is received indicating a new vehicle ID, the controller 222 may understand this to indicate a new vehicle is within the range 302. The controller 222 may maintain a counter indicative of the number of vehicles within the range 302 within a predefined amount of time. That is, for example, within a 60 second period, the controller 222 may count the number of vehicles.

The controller 222 may control the lights 230 according to the vehicle count. For example, whenever the vehicle count exceeds a predefined threshold count, the lights, or some subset thereof, within the cluster 226, may be turned on. On the converse, lights 230 that are currently on may be turned off when the vehicle count falls below the predefined threshold count. By monitoring the amount of vehicle traffic within a predefined time period, the lights 230 may be adjusted accordingly, thus saving on energy consumption and wear and tear of the light clusters 226. Furthermore, by using near-range wireless communication, the light clusters 226 may effectively receive local vehicle data.

Some roads or highways 306 may be associated with count thresholds based on the type of road. For example, a back road in a rural area may have a count threshold of once (1). That is, anytime a vehicle path 304 is predicted at the specific light 230, that light may be illuminated. On the other hand, a major highway in a metropolitan area may have a higher count threshold, for example, twenty (20). This may be because the area is already lit by other source (e.g., other lights, buildings, etc.) and additional light is only needed when higher traffic situations arise.

In one example, the light clusters 226 along the highway 306 may communicate with each other via short range wireless communications, similar to the vehicle-to-vehicle communications. A first light cluster may transmit acquired vehicle data to a second light cluster. The second light cluster may use this data to control the lights within the second cluster. By allowing the light clusters to communicate with each other, the receiving light cluster may receive vehicle data prior to the vehicle coming into the range of that respective light cluster.

Returning to FIG. 2, a light sensor 240 may be in communication with the controller 222 and may provide light sensor data indicative of the ambient light. In one example the light sensor 240 may be a photoresistor. The controller 222 may receive the light sensor data and control the highway lights 230 in response to the data. In one example, the lights 230 may be turned on in response to the ambient light falling below a predetermined threshold. In the example of a photoresistor, if the resistance exceeds a predetermined threshold resistance indicating a fall in light level, then the lights 230 may be turned on to provide light to the roadway 306.

FIGS. 3A-3C illustrate example situations for the lighting system 200. As explained above, FIG. 3A shows the vehicle 102 within the range 302 of the second light cluster 226-B. The vehicle 102 may be traveling along the vehicle path 304. Based on this path 304, as determined by the controller 222, certain lights 230 may be illuminated or turned on to light the road around the vehicle. In this example, each of the lights 230 within the path 304 have been illuminated. This includes all of the lights within the second light cluster 226-BA and the third light cluster 226-C. The lights in the fourth light cluster 226-D may remain off until the vehicle path 304 extends to the fourth cluster 226-D. As the vehicle 102 leaves the area surrounding a certain cluster 226 (e.g., the first light cluster 226-A), the lights 230 of that cluster may turn off to conserve resources.

FIG. 3B illustrates an example situation where a plurality of vehicles are traveling along the highway 306. Each of these vehicles 102 may transmit vehicle data to the light cluster 226. The controller 222 may then count the number of vehicles within the range 302 within a certain period of time. Whenever the vehicle count exceeds a predefined threshold count, within the time period, the lights, or some subset thereof, within the cluster 226 may be turned on. For example, anytime more than 10 vehicles are present within a 60 second period, the lights 230 may be turned on. Moreover, whenever the count falls below the threshold, the lights may then be turned off, creating a continually adjusting light system 200 based on traffic.

In one implementation, a first count threshold and a second count threshold may define a threshold range. That is, that the lights may remain on or off as long as the vehicle count falls within the threshold range. This may eliminate the lights turning on and off with great frequency (i.e. maintaining the light state) when a vehicle count changes by a small increment (e.g., 1 or 2 vehicles). By establishing a range, the lights may only change their current state when there is fluctuation outside of the range. For example, if the lights are on, and the vehicle count is above a first threshold (e.g., 10 vehicles), the lights remain on. When the vehicle count decreases to be below the first threshold but the count is still above a second threshold (e.g., 5 vehicles), the lights remain on. If the vehicle count decreases to be below the second threshold, then the lights may turn off. That is, in the given example, if the lights are currently on, they will stay on until the count falls below 5 vehicles. The light will be turned on again when the count exceeds 10 vehicles.

FIG. 3C illustrates an example situation where, similar to FIG. 3B, a plurality of vehicles are traveling along the highway 306 and each may transmit vehicle data to the light clusters 226. In this situation, while the vehicles are both within the range 302 of one of the light clusters 226, the lights 230 of the respective cluster 226 are not illuminated at least because the vehicle count does not exceed the count threshold in this example. Other reasons for the lights not being illuminated may include the ambient light being above the light threshold, the vehicles 102 not being close enough, etc.

In addition to the vehicle data including the current vehicle location and speed, the vehicle data may also include vehicle incidents such as accidents, traffic build-up, etc. In the example of an accident, the controller 222 associated with the light cluster 226 most nearby the accident may instruct the lights 230 thereof to blink, modulate, change color, etc., in order to draw attention thereto. These alterations may be construed as a warning to area drivers of an incident, as well as indicate the general location of the incident to first responders.

In these situations, certain lighting patterns may provide clues to area drivers as to the type of incident. In one example, a blinking red light may indicate an accident, a solid yellow light may indicate construction, an alternating red and blue light may indicate that emergencies vehicles are approaching, etc. Such lighting responses could also be based on the light sensor data. In one example, the light could be solid red at night or flashing red during the day.

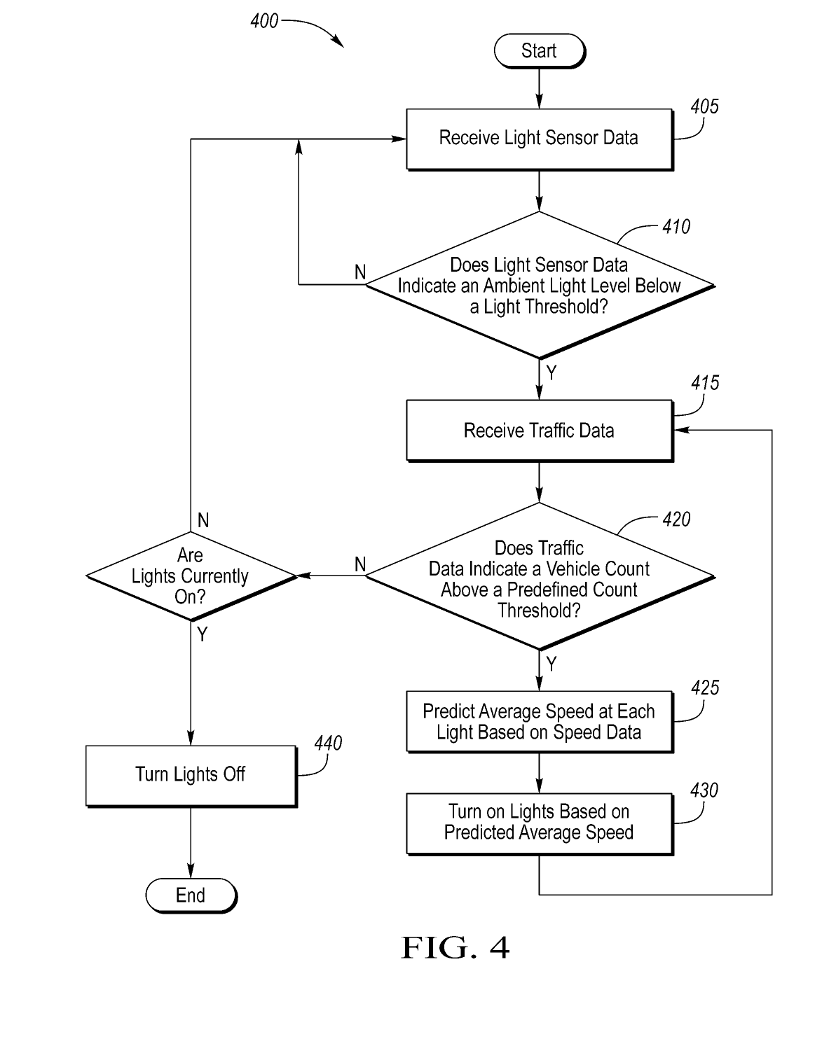

FIG. 4 illustrates an example process 400 for the lighting system 200. The process 400 begins at block 405 where the controller 222 may receive light sensor data from the light sensor 240. The light sensor data may include data indicative of the amount of ambient light.

At block 410, the controller 222 may determine whether the light sensor data indicates that the ambient light is below a predefined light threshold. If so, the process 400 proceeds to block 415. If not, the process 400 proceeds back to block 405.

At block 415, the controller 222 may receive traffic data. The traffic data may be included in the vehicle data received from nearby vehicles 102. As explained above, the traffic data may be compiled from various sets of vehicle data received from one or more vehicles. The traffic data may include a vehicle count indicative of a number of vehicles within the range 302 within a certain time period.

At block 420, the controller 222 may determine whether the traffic data indicates that a vehicle count exceeds the predefined count threshold. If so, the process 400 proceeds to block 425. If not, the process 400 proceeds to block 435.

At block 425, the controller 222 may predict the vehicle path 304. As explained above, the vehicle path 304 may be the expected path of the vehicle 102 for a certain time period. For example, the vehicle path 304 may be determined by estimating the vehicle's trajectory/distance for a predetermined time period based on the vehicle's current location and speed, as indicated by the received vehicle data. In the example shown in FIG. 3B, where multiple vehicles are on the highway 306, the vehicle path 304 may be determined based on the vehicle data of the first vehicle 102-A and the fourth vehicle 102-C (i.e., the first and last vehicle).

At block 430, the controller 222 may instruct the relays 232 to provide power the lights 230 along the vehicle path 304. In this example, the lights 230 along the highway within the second light cluster 226-B may be turned on, along with the lights 230 along the highway 306 within the third light cluster 226-B and a portion of the lights 230 along the highway 306 within the fourth light cluster 226-D, as shown in FIG. 3B. In another example, all of the lights 230 within an affected cluster may be turned on and off as along as a portion of the vehicle path 304 falls along the respective cluster 226.

The process 400 may proceed back to block 415. The lights 230 may remain on until the traffic data indicates that the vehicle count falls below the exceeds the predefined count threshold in block 420. In this instance, the process 400 will proceed to block 435.

At block 435, the controller 222 may determine whether lights 230 are currently on or illuminated. If so, the process 400 may proceed to block 440 where the lights 230 will be turned off to conserve resources. If not, the process 400 proceeds back to block 405.

Accordingly, a lighting system using vehicle-to-vehicle communication between area vehicles, as well as other lighting clusters, may effectively conserve energy by operating the lighting clusters based on the amount a traffic detected by the vehicle to vehicle data. The more vehicle data received, the more traffic on the highway, and thus an increased desire to more lighting.

Computing devices, such as the computing platform, processors, controllers, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included with in a computing device employing a computer operating system such as one of those mentioned above, and are accessed via a network and any one or more of a variety of manners. A file system may be accessible for a computer operating system, and make the files stored in various formats. An RDBMS generally employs the Structure Query Language (SQL) in addition to language for creating, storing, editing, and executing stored procedures, such as PL/SQL language mentioned above.

In some examples, system elements may be implemented as computer-readable instructions (e.g., software) on one or more computing devices (e.g., servers, personal computers, etc.) stored on computer readable media associated there with (e.g., disks, memories, etc.). A computer program product may comprise such instructions stored in computer readable media for carrying out the functions described herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A highway lighting system, comprising:
at least one light;
a transceiver; and
at least one controller configured to
receive vehicle data from a vehicle via vehicle-to-vehicle communication, the vehicle data indicating a vehicle count indicative of a number of vehicles transmitting vehicle data within a predefined radius of the transceiver, and
instruct the light to turn on in response to the vehicle count exceeding a traffic threshold.

2. The system of claim 1, wherein the controller is further configured to instruct the light to turn off in response to the vehicle data indicating a vehicle count falling below the threshold.

3. The system of claim 1, further comprising a light sensor configured to transmit light data to the controller, the controller configured to instruct the light to turn on in response to the light data indicating an ambient light level below a light threshold.

4. The system of claim 1, wherein the vehicle data includes at least one of a vehicle location and vehicle speed, the controller configured to determine a vehicle path based on the vehicle data and instruct the light to turn on in response to the vehicle path crossing the light.

5. The system of claim 1, wherein the vehicle count indicates a traffic level, the traffic threshold including a count threshold whereby the controller is configured to instruct the light to turn on in response to the vehicle count exceeding the count threshold.

6. The system of claim 5, wherein the vehicle count includes a number of vehicles transmitting vehicle data within a predefined time period.

7. A highway lighting system, comprising:
at least one light and at least one controller configured to
receive vehicle data indicative of at least one of a vehicle location and vehicle speed from a vehicle via vehicle-to-vehicle communication, and
determine a vehicle path based on the vehicle data and instruct the light to turn on in response to the vehicle path crossing the light.

8. The system of claim 7, wherein the vehicle data is indicative of a traffic level, wherein the controller is further configured to instruct the light to turn off in response to the vehicle data indicating a traffic level falling below a threshold.

9. The system of claim 8, wherein the traffic level includes a vehicle count indicative of a number of vehicles transmitting vehicle data within a predefined range of the controller, the traffic threshold including a count threshold whereby the controller is configured to instruct the light to turn on in response to the vehicle count exceeding the count threshold.

10. The system of claim 9, wherein the vehicle count includes a number of vehicles transmitting vehicle data within a predefined time period.

11. The system of claim 7, further comprising a light sensor configured to transmit light data to the controller, the controller configured to instruct the light to turn on in response to the light data indicating an ambient light level below a light threshold.

12. (canceled)

13. A vehicle-to-vehicle communication system, comprising:
at least one light and at least one controller configured to receive vehicle data indicative of vehicle traffic from a vehicle via vehicle-to-vehicle communication and to control a light state based on the vehicle traffic, wherein the light state changes when the vehicle data indicates vehicle traffic falling outside of a traffic range.

14. The system of claim 13, wherein the traffic range includes a first traffic threshold and a second traffic threshold, the controller configured to turn the light on in response to the vehicle traffic exceeding the first traffic threshold.

15. The system of claim 14, wherein the controller is further configured to turn the light off in response to the vehicle traffic falling below the second traffic threshold.
